(19) United States
(12) Patent Application Publication
(10) Pub. No.: US 2026/0199162 A1
(43) Pub. Date: Jul. 16, 2026

(54) PATIENT LIFT SLING BAR WITH BUMPER

(71) Applicant: Liko Research & Development AB, Lulea (SE)

(72) Inventors: Mathieu Bernard, Pluvigner (FR); Yoann Kersuzan, Pluvigner (FR); Pascal Francois Joseph Lemonnier, Pluvigner (FR)

(73) Assignee: Liko Research & Development AB, Lulea, OT (SE)

(21) Appl. No.: 19/444,633

(22) Filed: Jan. 9, 2026

Related U.S. Application Data
(60) Provisional application No. 63/744,829, filed on Jan. 13, 2025.

(51) Int. Cl. A61G 7/10

(52) U.S. Cl. CPC A61G 7/1063; A61G 7/1015; A61G 7/1042; A61G 7/1048; A61G 7/1051; A61G 2203/723

(57) ABSTRACT

A patient lift assembly includes a sling bar assembly. The sling bar assembly includes frame member and a sling bar bumper. The frame member is configured to be supported from the patient lift and to support a patient supporting sling. The frame member has an upper surface and a lower surface. A sling bar bumper is used to cover a portion of the frame member.

### CROSS-REFERENCE TO RELATED APPLICATIONS

This application claims priority under 35 U.S.C. § 119(e) to U.S. Provisional Application No. 63/744,829 filed on Jan. 13, 2025, the entire disclosure of which is incorporated herein by reference.

### BACKGROUND

The present disclosure relates to patient lift systems and particularly, to patient lift systems having a sling attached to a sling bar that is raised and lowered by a motor. More particularly, the present disclosure relates to systems and methods for enabling the motors of patient lift systems for operation.

Patient lift systems generally include a motor coupled to a sling bar to raise and lower the sling bar. A sling is attached to the sling bar and is configured to support and suspend a patient from the sling bar. The patient is raised and lowered in the sling by activating the motor. Such patient lift systems are sometimes used to move patients onto and off of patient support apparatuses. To attach the sling to the sling bar, loops of the sling are coupled to attachment hooks of the sling bar. A common type of sling has four loops, two of which are coupled to each hook of the sling bar. Failure to properly attach the correct pair of loops to the corresponding attachment hook may increase the risk of a patient fall. Thus, a patient lift system in which caregivers are assured of proper connection of the loops of slings to hooks of respective sling bars would be welcomed in the art.

In use, the sling bar is positioned directly above the head of a patient. The main purpose of sling bars for medical application is to perform a safe, secured and efficient link between the motorized lift and the sling on which the patient is installed. However, there is a risk of direct impact of the patient or the caregiver with the sling bar. This could result in head shock such as a potential contusion on the head (during installation, transfer and uninstallation). During walking rehabilitation, patient's head might continuously bump against the sling bar. This sometimes results in users being reluctant to use the product. While there are some known bumpers or covers for sling bars, there is the risk that external protection might be removed, lost. There is also a concern with the potential for cross-contamination. As such, any added protection must be cleanable and durable for multiple cleanings and multiple uses.

### SUMMARY

The present disclosure includes one or more of the features recited in the appended claims and/or the following features which, alone or in any combination, may comprise patentable subject matter.

According to a first aspect of the present disclosure, a sling bar assembly for a patient lift comprises a frame member and a sling bar bumper. The frame member is configured to be supported from the patient lift and to support a patient supporting sling. The frame member has an upper surface and a lower surface. The sling bar bumper covers the frame member to cover a portion of the lower surface of the frame member. The sling bar bumper includes at least two layers. An outer skin layer of the sling bar bumper is configured to be cleaned to prevent cross-contamination between users. An inner bumper layer of the sling bar bumper is configured to absorb shocks when the sling bar bumper contacts a portion of a person.

According to some embodiments of the first aspect of the present disclosure, the sling bar bumper is fixed to the frame member. In some embodiments, the sling bar bumper is fixed to the frame member by over-molding. In some embodiments, the sling bar bumper is fixed to the frame member by an adhesive. In some embodiments, the sling bar bumper is fixed to the frame member by a fastener.

According to other embodiments of the first aspect of the present disclosure, the sling bar bumper is removably secured to the frame member. In some embodiments, the sling bar bumper is removably secured to the frame member by an interference fit. In some embodiments, the sling bar bumper is removably secured to the frame member by a removable fastener. In some embodiments, the sling bar bumper is removably secured to the frame member by a hook and loop fasteners.

According to some embodiments of the first aspect of the present disclosure, the sling bar bumper comprises polyurethane foam.

According to some embodiments of the first aspect of the present disclosure, the sling bar bumper comprises neoprene.

According to some embodiments of the first aspect of the present disclosure, the sling bar bumper is formed to include areas of varying thickness to provide areas of varying bumpering.

According to some embodiments of the first aspect of the present disclosure, the frame member comprises a pair of hooks positioned at opposite ends of the frame member. In such embodiments, each hook is configured to receive a portion of the patient supporting sling, In such embodiments, the frame member includes an engagement portion that engages the patient lift and a pair of arms extending from the engagement portion, the hooks each supported from a respective arm such that the hooks are lower than the engagement portion and a clearance space is formed between the hooks when the sling bar assembly is in use.

According to some embodiments of the first aspect of the present disclosure, the frame member is formed to include external surface discontinuities and the sling bar bumper is formed to include internal surface discontinuities that are configured to engage with the external surface discontinuities of the frame member to secure the sling bar bumper to the frame member.

According to a second aspect of the present disclosure, a sling bar bumper for a sling bar of a patient lift assembly, the sling bar bumper comprises an outer skin layer configured to be cleaned to prevent cross-contamination between users, and an inner bumper layer having configured to absorb shocks when the sling bar bumper contacts a portion of a person.

According to some embodiments of the second aspect of the present disclosure, the sling bar bumper comprises a hook and loop fastener assembly configured to secure the sling bar bumper to the frame member.

According to some embodiments of the second aspect of the present disclosure, the sling bar bumper comprises polyurethane foam. According to some embodiments of the second aspect of the present disclosure, the sling bar bumper comprises neoprene.

According to some embodiments of the second aspect of the present disclosure, the sling bar bumper is formed to include areas of varying thickness to provide areas of varying bumpering.

According to some embodiments of the second aspect of the present disclosure, sling bar bumper is formed to include internal surface discontinuities that are configured to engage with external surface discontinuities of the frame member to secure the sling bar bumper to the frame member.

According to a third aspect of the present disclosure, a method of forming a sling bar assembly comprises forming a sling bar frame, forming a sling bar bumper, and engaging the sling bar bumper with the sling bar frame.

According to some embodiments of the third aspect of the present disclosure, forming the sling bar frame comprises forming a metal sling bar.

According to some embodiments of the third aspect of the present disclosure, forming a metal sling bar comprises machining a portion of the sling bar frame.

According to some embodiments of the third aspect of the present disclosure, forming a metal sling bar comprises casting a portion of the sling bar frame.

According to some embodiments of the third aspect of the present disclosure, forming a sling bar frame comprises forming surface discontinuities on an outer surface of the sling bar frame.

According to some embodiments of the third aspect of the present disclosure, forming the sling bar bumper comprises forming surface discontinuities on an inner surface of the sling bar bumper.

According to some embodiments of the third aspect of the present disclosure, engaging the sling bar bumper with the sling bar frame includes engaging the surface discontinuities on the inner surface of the sling bar bumper with the surface discontinuities on the outer surface of the sling bar frame to cause the sling bar bumper to be removably engaged with the sling bar frame.

According to some embodiments of the third aspect of the present disclosure, engaging the sling bar bumper with the sling bar frame includes over-molding the sling bar bumper onto the sling bar frame to fix the sling bar bumper to the sling bar frame.

According to some embodiments of the third aspect of the present disclosure, engaging the sling bar bumper with the sling bar frame includes fixing the sling bar bumper to the sling bar frame. In some embodiments, the sling bar bumper is fixed to the frame member by an adhesive. In some embodiments, the sling bar bumper is fixed to the frame member by a fastener.

According to some embodiments of the third aspect of the present disclosure, engaging the sling bar bumper with the sling bar frame includes removably securing the sling bar bumper to the sling bar frame. In some embodiments, the sling bar bumper is removably secured to the frame member by an interference fit. In some embodiments, the sling bar bumper is removably secured to the frame member by a removable fastener. In some embodiments, the sling bar bumper is removably secured to the frame member by a hook and loop fasteners.

Additional features, which alone or in combination with any other feature(s), such as those listed above and/or those listed in the claims, can comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

The detailed description particularly refers to the accompanying figures in which:

FIG. 1 is a front perspective view of an overhead patient lift system showing the patient lift system with a sling bar assembly according to the present disclosure;

FIG. 2 is a front perspective view of a mobile patient lift system showing the mobile patient lift system with a sling bar assembly according to the present disclosure;

FIG. 3 is an exploded perspective view of a sling bar assembly of the present disclosure showing a sling bar bumper that is attachable to a sling bar frame;

FIG. 4 is a perspective view of a sling bar assembly of the present disclosure with a sling bar bumper attached to a sling bar frame;

FIG. 5 is a cross-sectional view of the sling bar assembly of FIG. 4 taken along lines 5-5 and showing the sling bar bumper secured to the sling bar frame by an interference fit;

FIG. 6 is a view similar to FIG. 5, but showing another embodiment of a sling bar bumper secured to the sling bar frame by an interference fit;

FIG. 7 is a view similar to FIG. 5, but showing a sling bar bumper secured to the sling bar frame by a hook and loop fastening system, the sling bar bumper of FIG. 7 having multiple layers of varying materials;

FIG. 8 is a flow chart of a method for creating a sling bar assembly according to the present disclosure;

FIG. 9 is a flow chart of a sub-process of the method of FIG. 8, FIG. 9 showing alternative steps for forming sling bar frame; and

FIG. 10 is a flow chart of a method for over-molding a sling bar bumper to a sling bar.

### DETAILED DESCRIPTION

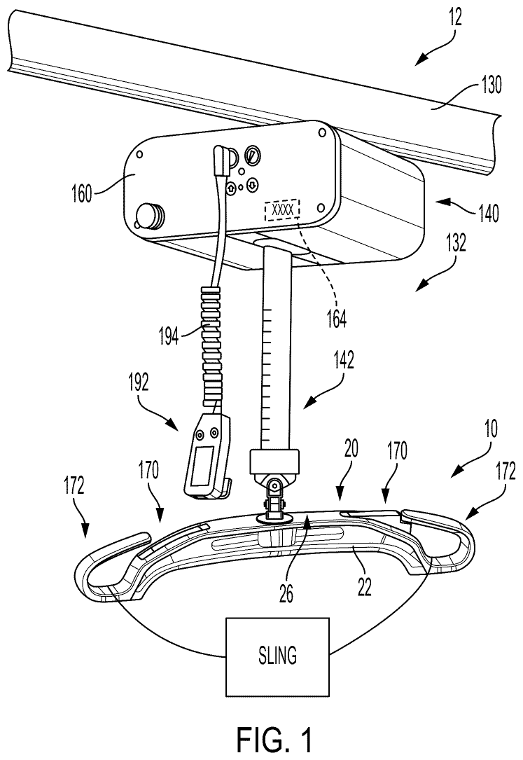

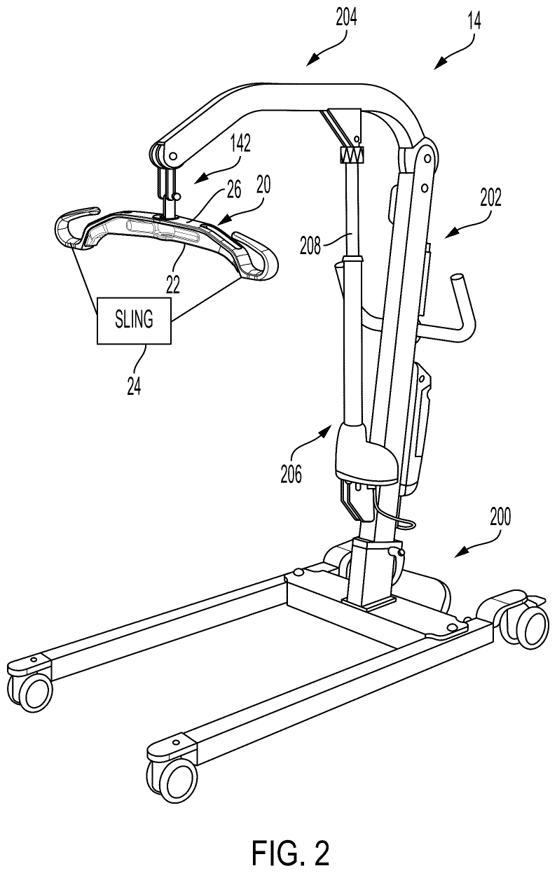

The present disclosure is related to a sling bar assembly 10 that is configured to be used with an overhead patient lift system 12 as shown in FIG. 1 or a mobile patient lift system 14 (e.g., a powered sit-to-stand lift or stand assist lift) shown in FIG. 2, or other person lifting devices. The structures of such systems are disclosed in U.S. Pat. No. 12,121,486, titled “PATIENT LIFT AND SLING HAVING WIRELESS COMMUNICATION,” issued Oct. 22, 2024, the entire disclosure of which is incorporated herein for the disclosure of patient lifts systems and related structures.

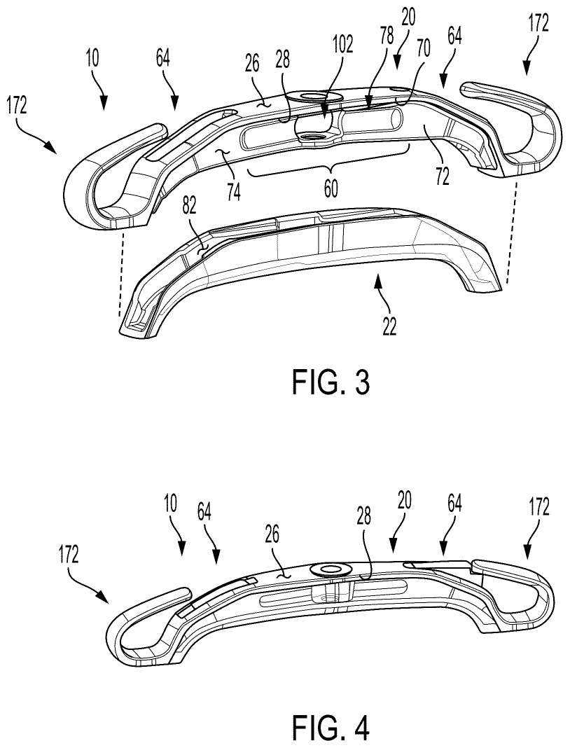

Referring to FIG. 3, the sling bar assembly 10 includes a frame member 20 and a sling bar bumper 22. The frame member 20 is configured to be supported from the patient lift system 12, 14 and to support a patient supporting sling 24. The frame member 20 has an upper surface 26 and a lower surface 28. When engaged with the frame member 20, the sling bar bumper 22 covers a portion of the lower surface 28 of the frame member 20. The sling bar bumper 22 extends along the full length of the lower surface 28 of the frame member 20. As will be discussed in further detail below, the design of the sling bar assembly 10 also achieves higher vertical head space with a set of hooks 172, 172. The sling bar bumper in the illustrative embodiment includes polyurethane. In some embodiments, other foams or neoprene rubber may be used. A material with a stiffness around 60 shore A has been found to offer a good shocks absorption combined with durability and surface cleanability.

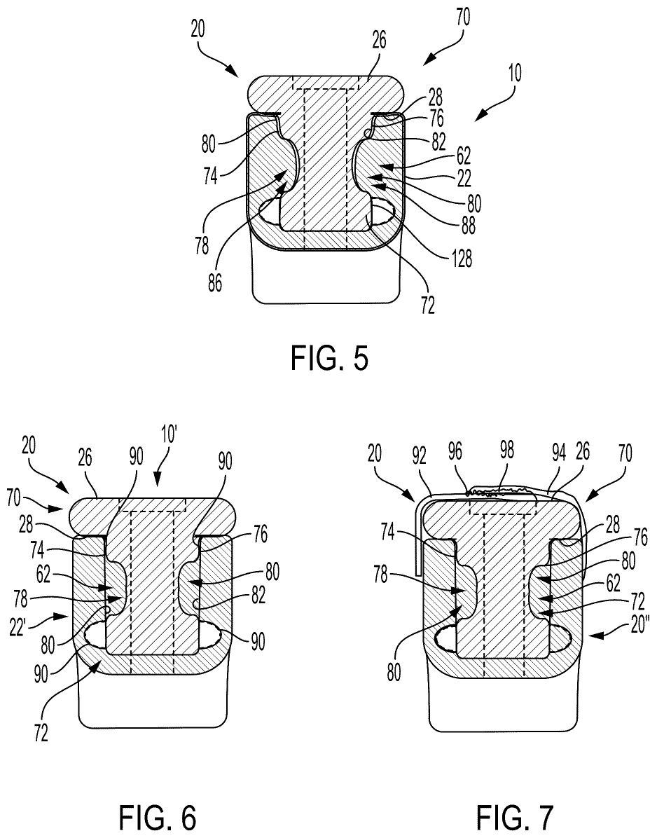

In the embodiment of FIGS. 3-5, the sling bar bumper 22 is fixed to the frame member 20 by an interference fit. The frame member 20 includes a main portion 60 that has a generally t-shaped cross-section 62 shown in FIGS. 5-7. Referring to FIGS. 3 and 4, a pair of arms 64, 66 extend from the main portion 60 and have a generally t-shaped cross-section as well. The main portion has an upper flange 70 and a leg 72 that extends downwardly from the upper flange 70. The flange 70 acts as a web to increase the stiffness of the frame member 20. Referring to FIG. 3, the leg 72 has external lateral surfaces 74, 76 on opposite lateral sides. Respective depressions 78, 80 are formed in the lateral surfaces 74, 76, the depressions 78, 80 acting as surface discontinuities which assist with retaining the sling bar bumper 22 on the sling bar frame member 20 as will be discussed in further detail below.

In the embodiment of FIGS. 3-5, the sling bar bumper 22 is molded to include opposing internal lateral surfaces 82, 84 that engage the lateral surfaces 74, 76 of the sling bar frame member 20. The sling bar bumper 22 includes a pair of protrusions 86, 88 formed on the internal lateral surfaces 82, 84 that are configured to engage the depressions 78, 80 formed on the external lateral surfaces 74, 76 of the frame member 20. In use, the surface discontinuities formed in the sling bar bumper 22 as protrusions 86, 88 engage the internal surface discontinuities formed in the frame member 20 as depressions 78, 80 to frictionally retain the sling bar bumper 22 on the frame member 20 under normal conditions. It is contemplated that the sling bar bumper 22 will be formed such that the respective surface discontinuities form an interference fit sufficient to retain the sling bar bumper 22 on the frame member 20. In some embodiments, the interface between the sling bar bumper 22 and the frame member 20 may further include a releasable adhesive that retains the sling bar bumper 22 so that remove requires a user to overcome both the interference fit and the releasable adhesive.

In another embodiment shown in FIG. 6, a sling bar bumper 22′ does not include the protrusions 86, 88. However, in such a case, an adhesive 90 may be applied between the sling bar bumper 22 and the frame member 20 to retain the sling bar bumper 22 to the frame member 20. Areas indicated by the reference numeral 90 in FIG. 5 are examples of the areas where the adhesive 90 may be placed to secure the sling bar bumper 22 to the frame member 20.

In still another embodiment shown in FIG. 7, a sling bar bumper 22″ may be secured to the frame member 20 by using straps 92, 94 that have complementary hook and loop fastening surfaces 96, 98 to releasably retain the sling bar bumper on the frame member 20. Those of ordinary skill in the art will recognize that the various retaining approaches discussed with regard to the embodiments of FIGS. 3-7 may each be used independently to releasably secure the embodiments of the sling bar bumper 22, 22′, and 22″ to the frame member 20, in some embodiments, multiple methods of releasably securing a sling bar bumper 22, 22′, 22″ may be used in combination.

It should be understood that while the embodiments of FIGS. 3-7 contemplate that the sling bar bumper 22 may be releasably secured to the frame member 20, in other embodiments, the sling bar bumper 22 may be permanently attached to the frame member 20. For example, a permanent adhesive that will not release may be used to secure the sling bar bumper 22 to the frame 20. In other embodiments, a sling bar bumper 22″′ may be secured to the frame member 20 by an over-molding process where a sling bar bumper 22″′ is permanently secured to the frame member 20. In such a case, the material that forms the sling bar bumper 22 will be distributed into various portions and discontinuities of the frame member 20 through the pressure of the over-molding process. For example, referring to FIG. 3, an opening 102 is formed through the leg 72 of the main portion 60 of the frame member 20. In the over-molding process, the material of the sling bar bumper 22 will be connected through the opening 102 and, as such, will help permanently secure the sling bar bumper 22 to the frame member 20. The process for achieving over-molding of the sling bar bumper 22 will be discussed in further detail below.

In the present disclosure, the sling bar bumper 22 comprises polyurethane foam. The sling bar bumper 22 includes an outer skin layer 128 (see FIGS. 5-7) of the sling bar bumper 22 that is configured to be cleaned to prevent cross-contamination between users. Such a skin may be achieved through various processes known in the art which cause the skin layer 128 to have closed cells that prevent the intrusion of microbes into the polyurethane. An inner bumper layer 30 of the sling bar bumper 22 is configured to absorb shocks when the sling bar bumper 22 contacts a portion of a person. In other embodiments, the sling bar bumper 22 may comprise neoprene. In some embodiments, the sling bar bumper 22 may include multiple layers of different materials, such as a layer of neoprene 32 and a layer of polyurethane 34, as shown in FIG. 7. In such a case, the layers and thicknesses are configured to optimize the protection for a user.

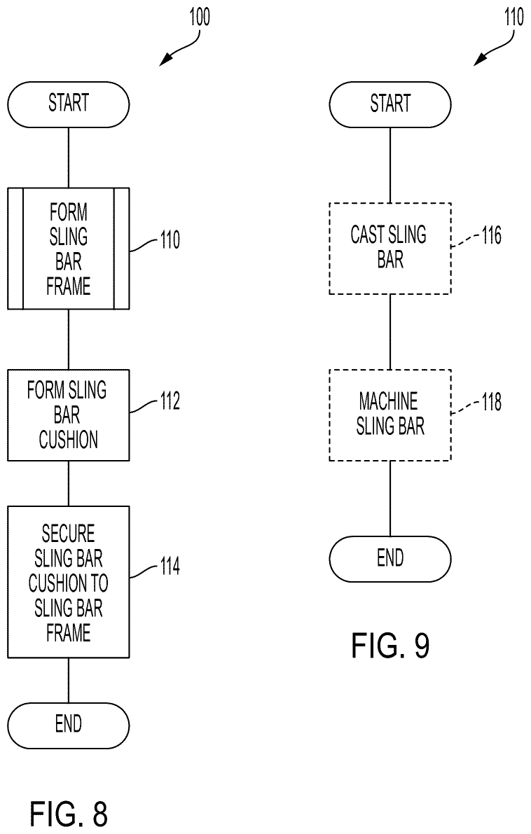

A process 100 for forming the sling bar assembly 10 is shown in FIG. 8 and includes a step 110 of forming a sling bar frame 20, a step 112 of forming a sling bar bumper 22, and a step 114 of engaging the sling bar bumper 22 with the sling bar frame 20. The sling bar frame 20 of the present disclosure includes a metal sling bar 52. The step 110 of forming the sling bar frame 20 may be further explained by reference to the steps of FIG. 9 where the step 110 is shown to be a sub-process that includes optional steps 116 and 118. The sling bar 52 may be formed by machining, casting, or other metal forming technique. As shown in FIG. 9, the step 116 of casting a raw sling bar is shown to be optional. Similarly, the step 118 of machining the raw sling bar to form a frame member 20 is also optional. In some embodiments, the frame member 20 may be cast in final form with no secondary machining at step 118 being necessary. In other embodiments, the frame member may be machined completely from a block of metal and step 116 may not be necessary.

While the discussion above with reference to the illustrative embodiment discusses the steps to form a metal frame member 20, in other embodiments, the sling bar frame member 20 may be molded of a structural resin having sufficient strength to support the loads experienced by the sling bar frame member 20. In other embodiments, the sling bar may be formed of carbon fiber material. The surface discontinuities on the outer surface of the sling bar frame member in such embodiments may be formed, either by molding or by machining, similar to the method of FIG. 9.

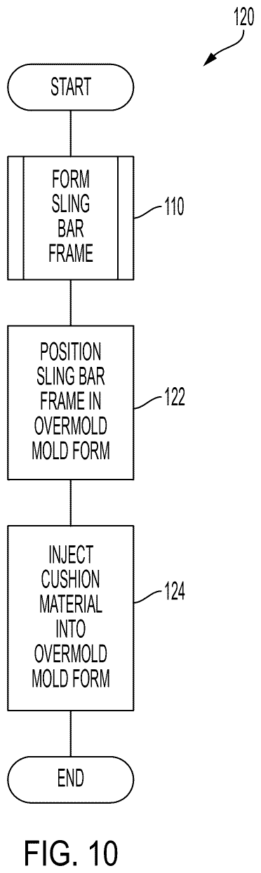

Referring now to FIG. 10, the method 120 for over-molding a sling bar bumper 22 onto a frame member 20 is disclosed to include the step 110 of forming the sling bar frame member 20 as discussed above with regard to FIGS. 8 and 9. Once the frame member 20 is formed, at step 122 the frame member 20 is positioned in an over-mold die form that is part of an injection molding machine. Once positioned in the over-molding machine, the process advances to step 124 where the polyurethane is injected into the mold form and allowed to cool to form the over-molded sling bar bumper 22. In some embodiments, the over-mold process may include multiple die forms that are used to progressively build the sling bar bumper 22 onto the frame 20. In such a case, the layers of the sling bar bumper 22 are built upon each other to provide the layer of varying thickness and stiffness to form an optimized sling bar assembly 10.

In use, the sling bar assembly 10 is used as part of either lift system 12, 14. The patient lift system 12 includes an overhead rail 130 coupled to a ceiling of a room and a lift assembly 132 configured to move along the rail 130. Rail 130 is included as part of a frame of the lift system 12. Some such frames are floor supported and have upright stanchions and the like to which rail 130 is coupled, rather than having rail 130 fixed to the ceiling.

The lift system 12 includes a lift 140, a strap 142 configured to be extended and retracted by the lift 140, the sling bar assembly 10 coupled to a lower end of the strap 142 by a coupler 144 such as a pin, latch, or hook, and the sling 24 (shown diagrammatically), as shown in FIG. 1. The lift 140 is configured to engage the rail 130 to permit the lift system 12 to be moved manually along the rail 130, a motor housing 162 coupled to a carriage 160, a motor 164 (shown diagrammatically) positioned in the housing 162 and configured to raise and lower the strap 142 by winding and unwinding the strap 142.

The sling bar assembly 10 is coupled to the end of the strap 142 and includes arms 170 with sling attachment hooks 172 at the ends of the arms 170. The sling attachment hooks 172 are configured to receive and removably retain loops of the sling 24. As disclosed in U.S. Pat. No. 12,121,486 discussed above, in use, the sling attachment hooks 172 include a retaining element that is configured to prevent the sling 24 from disengaging the attachment hooks 172. The retaining element may include a spring-loaded bail, finger, rod, post, or the like that is normally held in a closed position under the spring bias but that is movable to an open position during attachment of the loops of the sling 24 onto the respective hook 172. In use, the retaining elements prevent the loops of the sling 24 from inadvertently moving off of the respective hooks 172. The sling 24 is used to support the person being moved by the lift system 12. In some embodiments, the sling 50 can be one of the slings sold by Liko AB of Lulea, Sweden, such as, the Solo HighBack Model 25 sling.

The patient lift system 12 includes a handheld pendant 192 and a coiled cable 194 electrically coupling the pendant 192 to the circuitry within the housing 162 of lift system 12. The pendant allows a user to provide input indicative of the user's desire to raise and lower the sling 24.

Referring now to FIG. 2, the mobile patient lift system 14 includes a base 200, a lift mast 202 and a lift arm 204. In the configuration shown in FIG. 2, when an actuator 206 is extended, the patient is lifted. Accordingly, raising and lowering the lift arm 204 with respect to the base 200 is achieved using an actuator such as a lift actuator 206. In the embodiments shown, the lift actuator 206 is a linear actuator that drives an output shaft 208. Extension and retraction of the output shaft 208 causes lift arm 204 to pivot relative to mast 202.

While the disclosure has been illustrated and described in detail in the drawings and the foregoing description, such illustration and description are to be considered illustrative or exemplary and not restrictive. The disclosure is not limited to the disclosed embodiments. From reading the present disclosure, other modifications will be apparent to a person skilled in the art. Such modifications may involve other features, which are already known in the art and may be used instead of or in addition to features already described herein. In the claims, the word “comprising” does not exclude other elements or steps, and the indefinite article “a” or “an” does not exclude a plurality.

Although this disclosure refers to specific embodiments, it will be understood by those skilled in the art that various changes in form and detail may be made without departing from the subject matter set forth in the accompanying claims.

1. A sling bar assembly for a patient lift comprising
a frame member configured to be supported from the patient lift, the frame member being configured to support a patient supporting sling, the frame member having an upper surface and a lower surface, and
a sling bar bumper covering the frame member to cover a portion of the lower surface of the frame member, the sling bar bumper including at least two layers including an outer skin layer configured to be cleaned to prevent cross-contamination between users and an inner bumper layer having configured to absorb shocks when the sling bar bumper contacts a portion of a person.

2. The sling bar assembly of claim 1, wherein the sling bar bumper is fixed to the frame member.

3. The sling bar assembly of claim 1, wherein the sling bar bumper is removably secured to the frame member.

4. The sling bar assembly of claim 3, wherein the sling bar bumper is removably secured to the frame member by an interference fit.

5. The sling bar assembly of claim 4, wherein the sling bar bumper is removably secured to the frame member by a hook and loop fasteners.

6. The sling bar assembly of claim 1, wherein the sling bar bumper comprises polyurethane foam.

7. The sling bar assembly of claim 6, wherein the sling bar bumper is formed to include areas of varying thickness to provide areas of varying bumpering.

8. The sling bar assembly of claim 7, wherein the sling bar bumper comprises neoprene.

9. The sling bar assembly of claim 1, wherein the frame member comprises a pair of hooks positioned at opposite ends of the frame member, each hook configured to receive a portion of the patient supporting sling, the frame member having an engagement portion that engages the patient lift and a pair of arms extending from the engagement portion, the hooks each supported from a respective arm such that the hooks are lower than the engagement portion and a clearance space is formed between the hooks when the sling bar assembly is in use.

10. The sling bar assembly of claim 1, wherein the frame member is formed to include external surface discontinuities and the sling bar bumper is formed to include internal surface discontinuities that are configured to engage with the external surface discontinuities of the frame member to secure the sling bar bumper to the frame member.

11. A sling bar bumper for a sling bar of a patient lift assembly, the sling bar bumper comprising
an outer skin layer configured to be cleaned to prevent cross-contamination between users, and
an inner bumper layer having configured to absorb shocks when the sling bar bumper contacts a portion of a person.

12. The sling bar bumper of claim 11, wherein the sling bar bumper comprises a hook and loop fastener assembly configured to secure the sling bar bumper to the frame member.

13. The sling bar bumper of claim 11, wherein the sling bar bumper comprises polyurethane foam.

14. The sling bar bumper of claim 13, wherein the sling bar bumper is formed to include areas of varying thickness to provide areas of varying bumpering.

15. The sling bar bumper of claim 11, wherein sling bar bumper is formed to include internal surface discontinuities that are configured to engage with external surface discontinuities of a frame member to secure the sling bar bumper to the frame member.

16. A method of forming a sling bar assembly comprising forming a sling bar frame, forming a sling bar bumper, and engaging the sling bar bumper with the sling bar frame.

17. The method of claim 16, wherein forming the sling bar frame comprises forming a metal sling bar.

18. The method of claim 16, wherein forming a sling bar frame comprises forming surface discontinuities on an outer surface of the sling bar frame.

19. The method of claim 18, wherein forming the sling bar bumper comprises forming surface discontinuities on an inner surface of the sling bar bumper.

20. The method of claim 19, wherein engaging the sling bar bumper with the sling bar frame includes engaging the surface discontinuities on the inner surface of the sling bar bumper with the surface discontinuities on the outer surface of the sling bar frame to cause the sling bar bumper to be removably engaged with the sling bar frame.
